(19) United States
(12) Patent Application Publication
(10) Pub. No.: US 2019/0281352 A1
(43) Pub. Date: Sep. 12, 2019

(54) Digital Signage Method and System for Implementing the Same

(71) Applicant: JR East Media Co.,Ltd., Tokyo (JP)

(72) Inventors: Ryoji KOSHI, Tokyo (JP); Akira OKABE, Tokyo (JP)

(21) Appl. No.: 16/033,629

(22) Filed: Jul. 12, 2018

(30) Foreign Application Priority Data
Mar. 7, 2018 (JP) 2018-40430

(51) Int. Cl. H04N 21/458; H04N 21/45; H04N 21/262

(52) U.S. Cl. CPC H04N 21/458; H04N 21/26241; H04N 21/4524

(57) ABSTRACT

[Problem to be Solved] To provide a digital signage method and a system for implementing the same that perform content distribution, and the like, to each particular reproduction terminal without depending on the public line network, allowing it to avoid occurrence of a problem, such as an illegal alteration of a distribution content, and also to make schedule management of each particular reproduction terminal, being based on the time setting.

[Solution] A digital signage system, including a portable terminal 1, a plurality of reproduction terminals 3, and a plurality of digital signage displays 4, the portable terminal 1 storing the data of the contents to be displayed on the plurality of digital signage displays 4, together with schedule data including the order of display and the time frame of display of the contents, and display conditions, and distributing the content data, together with the schedule data and the display conditions, to the plurality of reproduction terminals 3, which are connected thereto via a Wi-Fi network, in an individual or simultaneous manner; and the plurality of reproduction terminals 3 causing the content data, which has been distributed from the portable terminal 1, to be displayed by the plurality of displays 4 according to said schedule data.

### TECHNICAL FIELD

The present invention relates to a digital signage method and a system for implementing the same, and more particularly to a digital signage method and a system for implementing the same for operating a digital signage to display various types of advertisements and pieces of information on a signage terminal, which provides a display for advertisement that is disposed in such a place as a station yard or a shop, such that the various types of advertisements and pieces of information are viewed by passers-by.

### BACKGROUND ART

The digital signage has found wide-spread use because it offers such advantages that it is capable of setting a particular viewer target with the regional characteristics of the installation location being taken into account, and transmitting an advertising message focused on such particular viewer target; that it allows using a communication network for making a real-time operation and information distribution; and that it eliminates the need of time and labor which would be required in changing printed matters, such as posters and roll-screen signboards.

Generally, a system for implementing digital signage is configured including a display provided with an attached reproduction terminal for displaying characters, videos, and still pictures by means of such a device as a plasma display, LCD, LED, VFD, or image projector; a signage server, which is a control section having an image display control part and a communication control part, together with a storage device to hold information about videos and still pictures; a digital communication path for receiving display information from an advertisement distribution source through a public line network, such as the Internet, and sending back the result of operation confirmation as required; and a storage (such as a built-in memory or a memory card) that saves various types of information for advertisement.

And, the schedule management of displaying the contents on each particular display, in other words, the management of the date of display, the time frame of display, the time period of display, and the like, for every content to be displayed is performed by the signage server through the Internet, or the like.

### CITATION LIST

### Patent Literature

[Patent Literature 1] Japanese Patent Publication No. 2016-91421

[Patent Literature 2] Japanese Patent Publication No. 2015-90600

### SUMMARY OF INVENTION

### Technical Problem

As described above, the system for implementing digital signage is generally configured including a display provided with an attached reproduction terminal, a signage server, and the like, which are connected to one another through the Internet, whereby there can be caused a problem that a distribution content may be illegally accessed and subjected to an illegal alteration. And if, in order to avoid occurrence of such a situation, each particular reproduction terminal is specified to be of standalone type, there occurs an inconvenience that it is impossible to perform time setting for each particular reproduction terminal, resulting in the schedule management thereof becoming impossible to be made, which has presented a difficulty in implementing the digital signage.

Then, the present invention has been made to solve such a difficulty, and it is an object of the present invention to provide a digital signage method and a system for implementing the same that perform content distribution, and the like, to each particular reproduction terminal without depending on the public line network, allowing avoidance of occurrence of a problem, such as an illegal alteration of a distribution content, and also making schedule management of each particular reproduction terminal, being based on the time setting.

### Solution to Problem

The invention claimed in claim 1 to solve the above-mentioned difficulty is a digital signage method, including:

a step in which said content data that has been prepared is transferred to a portable terminal not via a public line network;

a step in which, in said portable terminal, a distribution list (of contents) for a reproduction terminal that controls a display is prepared for each particular reproduction terminal, and from said portable terminal to said reproduction terminal that is connected thereto via a Wi-Fi network, said distribution list (of contents) corresponding to the reproduction terminal is distributed;

a step in which, in said portable terminal, a distribution list (of distribution settings) for a reproduction terminal that controls a display is prepared for each particular reproduction terminal, and from said portable terminal to said reproduction terminal that is connected thereto via a Wi-Fi network, said distribution list (of distribution settings) corresponding to the reproduction terminal is distributed;

a step in which, in said each particular reproduction terminal, schedule management based on the time setting utilizing a GPS is performed;

a step in which, from said reproduction terminal, content data contained in said distribution list is transmitted to said display according to the schedule data associated therewith; and

a step in which, on said display, said content data is displayed, according to said schedule data.

Said distribution list (of contents) includes a terminal ID of said display, and types of content to be displayed on the display, and said distribution list (of distribution settings) includes schedule data including the term of display, the order of display, the time frame of display, and the reproduction time of each content, and display conditions.

The invention claimed in claim 3 to solve the above-mentioned difficulty is a digital signage system, including:

a portable terminal, a plurality of reproduction terminals, and a plurality of digital signage displays that are installed in specified locations to display contents comprised of characters, videos, and still pictures,

said portable terminal storing the data of said contents to be displayed on said plurality of digital signage displays, together with schedule data including the order of display and the time frame of display of said contents, and display conditions, such as the effect (the fade-in or fade-out effect, or the like), and the direction of display (the direction of top to bottom, that of left to right, or that of right to left), and distributing said content data, together with said schedule data and said display conditions, to said plurality of reproduction terminals, which are connected thereto via a Wi-Fi network, in an individual or simultaneous manner; and

said plurality of reproduction terminals causing said content data, which has been distributed from the portable terminal, to be displayed by said plurality of displays according to said schedule data.

In one embodiment, said reproduction terminal has a GPS function, allowing schedule management based on the time setting utilizing a GPS. In addition, said reproduction terminal is an STB (Set Top Box) that is connected to an HDMI (trademark) terminal provided for said display.

### Advantageous Effects of Invention

The present invention is as described above, and with the digital signage method and the system for implementing the same in accordance with the present invention, distribution of content data, and the like, to a particular reproduction terminal is performed not via a public line network, and thus there is no possibility of occurrence of a problem, such as an illegal access to or an illegal alteration of a distribution content, and the like, with an advantage being offered that the schedule management function based on the time setting utilizing a GPS that is possessed by each particular reproduction terminal allows reproduction of a content on the basis of a safe and exact schedule.

### BRIEF DESCRIPTION OF DRAWINGS

FIG. 1 is a simplified block diagram illustrating the configuration of a digital signage system in accordance with the present invention;

FIG. 2 is a flowchart illustrating the flow of operations of processing by a digital signage method in accordance with the present invention;

FIGS. 3A-3B shows a set of screens of a portable terminal indicating how an operation of distributing a distribution list (of contents) (the step of distributing a distribution list <of contents>) is performed;

FIGS. 4A-4C shows another set of screens of a portable terminal indicating how an operation of distributing a distribution list (of contents) (the step of distributing a distribution list <of contents>) is performed;

FIGS. 5A-5C shows a set of screens of a portable terminal indicating how an operation of distributing a distribution list (of distribution settings) (the step of distributing a distribution list <of distribution settings>) is performed; and

FIG. 6 shows another screen of a portable terminal indicating how an operation of distributing a distribution list (of distribution settings) (the step of distributing a distribution list <of distribution settings>) is performed.

### DESCRIPTION OF EMBODIMENTS

Hereinbelow, an embodiment of the present invention will be explained with reference to the attached drawings. A digital signage method in accordance with the present invention is comprised of a step in which content data is prepared; a step in which said content data that has been prepared is transferred to a portable terminal not via a public line network; a step in which, in said portable terminal, a distribution list (of contents) for a reproduction terminal that controls a display is prepared for each particular reproduction terminal, and from said portable terminal to said reproduction terminal that is connected thereto via a Wi-Fi network, said distribution list (of contents) corresponding to the reproduction terminal is distributed; a step in which, in said portable terminal, a distribution list (of distribution settings) for a reproduction terminal that controls a display is prepared for each particular reproduction terminal, and from said portable terminal to said reproduction terminal that is connected thereto via a Wi-Fi network, said distribution list (of distribution settings) corresponding to the reproduction terminal is distributed; a step in which, in said each particular reproduction terminal, schedule management based on the time setting utilizing a GPS is performed; a step in which, from said reproduction terminal, content data contained in said distribution list is transmitted to said display according to the schedule data associated therewith; and a step in which, on said display, said content data is displayed, according to said schedule data.

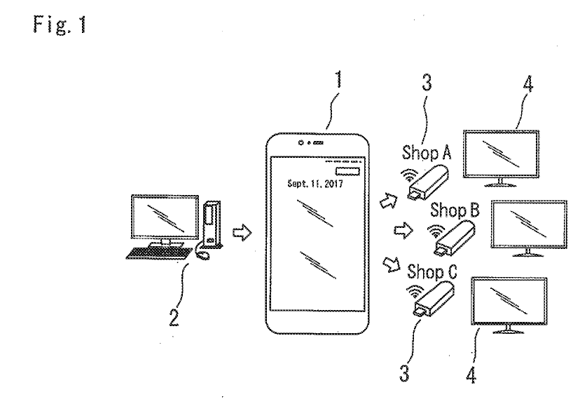

A digital signage system in accordance with the present invention is a system for implementing the above-described digital signage method, including, as shown in FIG. 1, a portable terminal 1, a plurality of reproduction terminals 3, and a plurality of digital signage displays 4 that are installed in specified locations to display contents comprised of characters, videos, and still pictures, the portable terminal 1 preparing distribution lists (of contents) for distributing content data to be displayed by the plurality of digital signage displays 4, and distribution lists (of distribution settings) for distributing the schedule data including the order of display and the time frame of display, and the display conditions, such as the effect (the fade-in or fade-out effect, or the like), and the direction of display (the direction of top to bottom, that of left to right, or that of right to left), and distributing the distribution lists to the plurality of reproduction terminals 3, which are connected thereto via a Wi-Fi network, in an individual or simultaneous manner; and the plurality of reproduction terminals 3 causing the content data, which has been distributed from the portable terminal 1, to be displayed by the plurality of displays 4 according to the schedule data.

As the portable terminal 1, a smart phone is generally used. The reproduction terminal 3 incorporates a GPS module for implementing the GPS function, whereby it is possible to perform schedule management utilizing a GPS. In other words, the GPS module adjusts the time and date from the exact time and date information based on an atomic clock and the information about the time zone in which the atomic clock exists. In one embodiment, the reproduction terminal 3 is an STB that is connected to an HDMI (registered trademark) terminal disposed in the display 4.

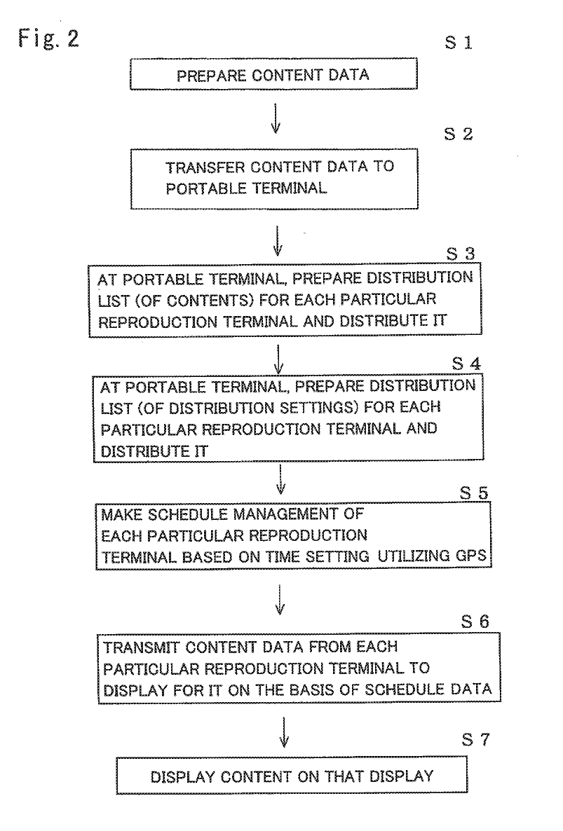

Hereinbelow, the flow of operations of processing by the digital signage method in accordance with the present invention that utilizes the digital signage system configured as described above will be explained with reference to FIG. 2.

Contents Preparation Step (S1)

At this step (S1), with a personal computer 2 for preparing contents, a plurality of types of content data to be displayed by each particular display 4 are prepared.

Content Data Transfer Step (S2)

At this step (S2), the plurality of types of content data that have been prepared are directly transferred to the portable terminal 1 by use of such a means as a USB, not via a public line network, and stored therein for preparing the following two different types of distribution list, i.e., a distribution list (of contents) and a distribution list (of distribution settings).

Distribution List (of Contents) Distribution Step (S3)

At this step (S3), with the portable terminal 1, a distribution list (of contents) is prepared for each particular reproduction terminal (STB) 3 that is connected thereto via a Wi-Fi network, and distributed to the particular reproduction terminal (STB) 3. Such distribution list includes the terminal ID of a particular display 4, and the types of content to be displayed by the particular display 4.

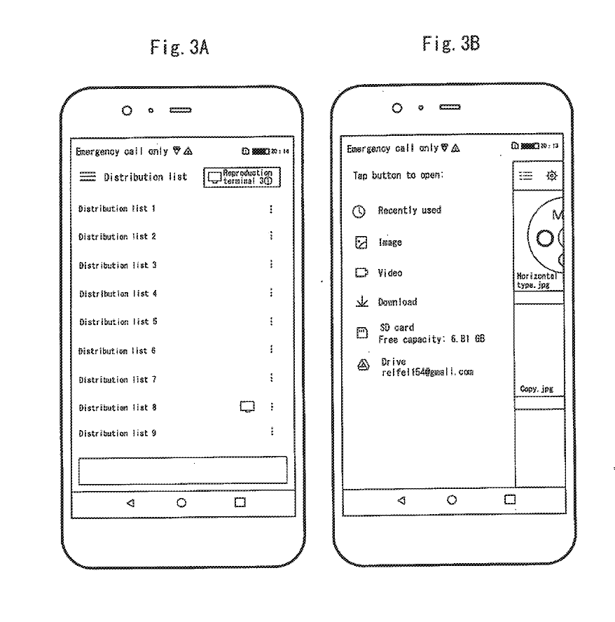

FIG. 3 (3A) shows a distribution list (of contents) for each particular reproduction terminal 3. First, from the screen shown in FIG. 3(A), a distribution list to be edited is tapped to display the list of contents, and from among it, a plurality of contents to be distributed to the reproduction terminal 3 are selected and tapped to determine the distribution list. The “television set-shaped icon” given at right of the distribution list name represents the distribution list that has been transmitted to the reproduction terminal selected, and in the example shown in FIG. 3(A), it can be known that the “distribution list 8” has been sent to the reproduction terminal.

In the case where contents other than those given in the “distribution list 8” are to be indicated, the add button provided on the contents indication screen is tapped to cause the selection buttons for image, video, download, and SD card to be shown up (FIG. 3(B)).

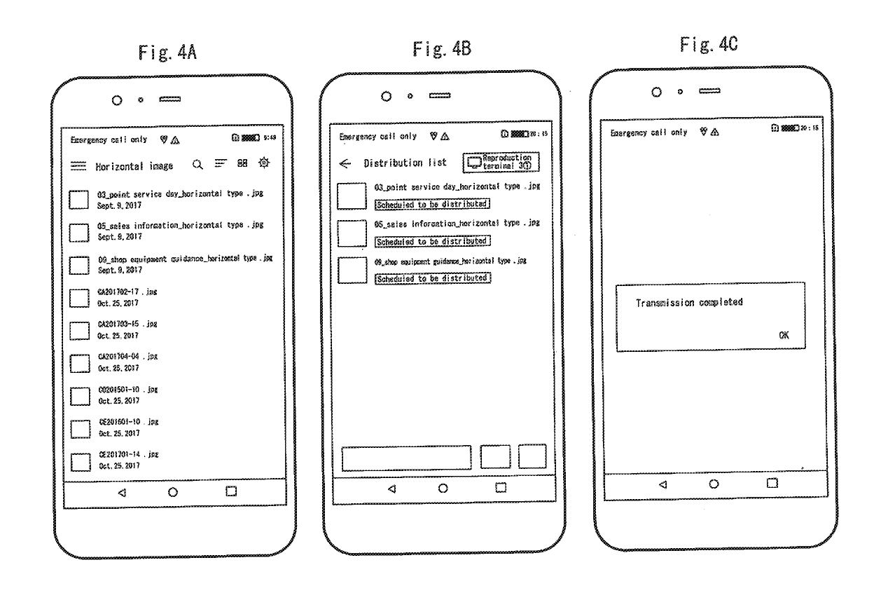

Then, for example, if the SD card button is tapped, the content folders that are saved in the SD card are invoked. FIG. 4(A) shows a horizontal image folder among them. If a plurality of contents to be displayed on the reproduction terminal 3 are selected from among the contents saved in the horizontal image folder, and tapped, they are given in parallel on the screen as the contents that are scheduled to be transmitted (FIG. 4(B)). When, after the contents having been edited, the sending button is tapped, the contents that have been sent to the reproduction terminal 3 will be indicated in parallel as those that have been sent. In FIG. 4(C), it is indicated that the “distribution list 1”, which has been subjected to an editing operation, has been sent to the reproduction terminal 3.

Distribution List (of Distribution Settings) Distribution Step (S4)

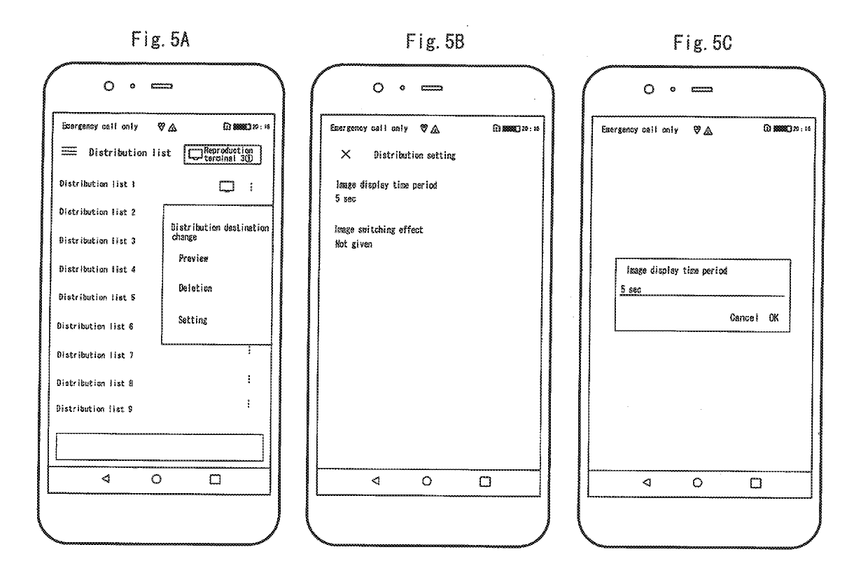

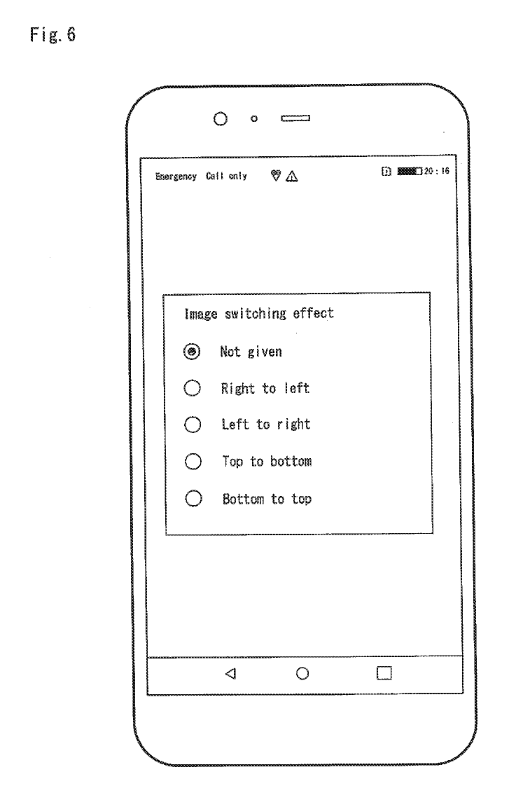

At this step (S4), distribution setting (setting of schedule data and display conditions) is carried out for each particular content that has been sent, and the distribution list (of distribution settings) that has been prepared is sent to the pertinent reproduction terminal 3. In order to carry out such distribution setting, first, in the screen shown in FIG. 3(A), the icon (which is formed of three dots vertically arranged) at the right of the name of the distribution list with which distribution setting is to be made is tapped, the setting button will be shown up (FIG. 5(A)). Then, tapping that setting button will invoke the setting screen (FIG. 5(B)). On that setting screen, the schedule data, such as the time period of image display (FIG. 5(C)), the term of display, the order of display, and the time frame of display, is set, and the schedule data that has been set is transmitted to the particular reproduction terminal 3. Then, on the setting screen shown in FIG. 6, the display conditions, such as the effect (the fade-in or fade-out effect, or the like), and the direction of display (the direction of top to bottom, that of left to right, or that of right to left), are set, and the display conditions that have been set are transmitted to the particular reproduction terminal 3.

Schedule Management Step (S5)

At this step (S5), in each particular reproduction terminal 3, schedule management utilizing a GPS is performed. In other words, each particular reproduction terminal 3 always acquires the exact time and date information with the use of a GPS module incorporated therein, having a function for making schedule management such that each particular type of content data that is included in the distribution list (of contents) can be transmitted to the pertinent display 4 according to the schedule data associated therewith.

Content Data Transmission Step (S6)

At this step (Step 6), as described above, each particular reproduction terminal 3 performs schedule management of each particular content that has been sent from the portable terminal 1 and stored therein for such a matter as the time at which it is to be displayed on the display 4, and with a prescribed time being reached, the particular content data is sent to the display 4 according to the display conditions.

Display Displaying Step (S7)

At this step (S7), a particular content that has been transmitted from the particular reproduction terminal 3 is displayed on the display 4.

Distribution of the distribution list (of contents or distribution settings) from the portable terminal 1 to each particular reproduction terminal 3 (which is carried out at step S3 or S4, respectively) is often performed in an individual manner by tapping a terminal ID button on the menu screen to select a particular reproduction terminal 3, however, in the case where a particular distribution list to be distributed to each particular reproduction terminal 3 is that to be commonly used by all the reproduction terminals 3, it may be distributed in a simultaneous manner.

### INDUSTRIAL APPLICABILITY

The digital signage method and the system for implementing the same in accordance with the present invention are those as described above, and with such method and system for implementing the same, distribution of content data, and the like, to a particular reproduction terminal is performed not via a public line network, and thus there is no possibility of occurrence of a problem, such as an illegal access to or an illegal alteration of a distribution content, and the like, with an advantage being offered that the schedule management function based on the time setting utilizing a GPS that is possessed by each particular reproduction terminal allows reproduction of a content on the basis of a safe and exact schedule, whereby a great industrial applicability is assured.

1. A digital signage method, comprising:
a step in which content data is prepared;
a step in which said content data that has been prepared is transferred to a portable terminal not via a public line network;
a step in which, in said portable terminal, a distribution list (of contents) for a reproduction terminal that controls a display is prepared for each particular reproduction terminal, and from said portable terminal to said reproduction terminal that is connected thereto via a Wi-Fi network, said distribution list (of contents) corresponding to the reproduction terminal is distributed;
a step in which, in said portable terminal, a distribution list (of distribution settings) for a reproduction terminal that controls a display is prepared for each particular reproduction terminal, and from said portable terminal to said reproduction terminal that is connected thereto via a Wi-Fi network, said distribution list (of distribution settings) corresponding to the reproduction terminal is distributed;
a step in which, in said each particular reproduction terminal, schedule management based on the time setting utilizing a GPS is performed;
a step in which, from said reproduction terminal, content data contained in said distribution list is transmitted to said display according to the schedule data associated therewith; and
a step in which, on said display, said content data is displayed, according to said schedule data.

2. The digital signage method according to claim 1, wherein said distribution list (of contents) includes a terminal ID of said display, and types of content to be displayed on the display, and said distribution list (of distribution settings) includes schedule data including the term of display, the order of display, the time frame of display, and the reproduction time of each content, and display conditions.

3. A digital signage system, comprising:
a portable terminal, a plurality of reproduction terminals, and a plurality of digital signage displays that are installed in specified locations to display contents comprised of characters, videos, and still pictures,
said portable terminal storing the data of said contents to be displayed on said plurality of digital signage displays, together with schedule data including the order of display and the time frame of display of said contents, and display conditions, such as the effect (the fade-in or fade-out effect, or the like), and the direction of display (the direction of top to bottom, that of left to right, or that of right to left), and distributing said content data, together with said schedule data and said display conditions, to said plurality of reproduction terminals, which are connected thereto via a Wi-Fi network, in an individual or simultaneous manner; and
said plurality of reproduction terminals causing said content data, which has been distributed from the portable terminal, to be displayed by said plurality of displays according to said schedule data.

4. The digital signage system according to claim 3, wherein said reproduction terminal has a GPS function, allowing schedule management based on the time setting utilizing a GPS.

5. The digital signage system according to claim 3, wherein said reproduction terminal is an STB that is connected to an HDMI (trademark) terminal provided for said display.

6. The digital signage system according to claim 4, wherein said reproduction terminal is an STB that is connected to an HDMI (trademark) terminal provided for said display.
